(19) United States
(12) Patent Application Publication
(10) Pub. No.: US 2026/0338303 A1
(43) Pub. Date: Oct. 29, 2026

(54) Female End-Piece for a Fluidic Connector

(71) Applicant: HUTCHINSON, CLICHY (FR)

(72) Inventors: Antoine THILLET, MONTARGIS (FR); Julien MONGENDRE, SURY AUX BOIS (FR)

(21) Appl. No.: 19/655,911

(22) Filed: Apr. 23, 2026

(30) Foreign Application Priority Data
Apr. 24, 2025 (FR) 2504344

(51) Int. Cl. F16L 21/08

(52) U.S. Cl. CPC F16L 21/08; F16L 2201/10

(57) ABSTRACT

Disclosed is a female end-piece for a fluidic connector. The female end-piece comprises a tubular body comprising an internal passage defining at least one fluid inlet and at least one fluid outlet, an annular sealing gasket, a retaining ring for retaining the gasket in the passage, and a movable indicator carried by the ring.

### CROSS REFERENCE TO RELATED APPLICATION

This present application claims priority to French Patent Application No. 2504344, filed Apr. 24, 2025, the disclosure of which is hereby incorporated by reference in its entirety.

### TECHNICAL FIELD

The disclosure relates to a female end-piece for a fluidic connector and to a fluidic connector comprising such a female end-piece.

### BACKGROUND

The prior art is illustrated by the documents FR-A1-2891889, US-B2-7316425, EP-A1-1972846 and FR-A1-3082586.

Typically, a fluidic connector comprises two end-pieces, one male and one female, which are configured to be engaged one inside the other. Each of the end-pieces is connected to a pipe or a tube and allows these pipes or these tubes to be connected together. This type of fluidic connector may be found in many fields, for example in the automotive industry, for an air conditioning system for example.

A fluidic connector is generally equipped with at least one sealing gasket that provides a sealing between the male and female end-pieces. The sealing gasket may be carried by the male end-piece and co-operate with the female end-piece, or conversely may be carried by the female end-piece and co-operate with the male end-piece.

The present disclosure relates to this second configuration wherein the female end-piece carries a sealing gasket which is configured to cooperate with the male end-piece.

For example, a female end-piece is known which comprises an internal annular seat wherein a sealing gasket is housed. Due to industrial constraints, it is not possible to produce a complete seat in the female end-piece. This seat is partly defined by a body of the female end-piece and partly by a ring fitted and attached in the end-piece.

The body of the female end-piece comprises an internal cylindrical surface and a first annular face extending inwardly from a first axial end of the cylindrical surface.

The retaining ring is mounted on the side of a second axial end of the cylindrical surface, opposite said first end. This ring defines a second annular face which is axially opposite the first annular face and which defines with it the gasket mounting seat.

In the current technique, the ring is force-fitted inside the end-piece by translating the ring along the axis of engagement of the male end-piece in the female end-piece. It is engaged in the female end-piece up to a housing located on the side of the second aforementioned end and which comprises a bead in the form of a projecting ridge.

However, this configuration has its disadvantages. Firstly, the mounting of the ring in the female end-piece is performed using a machine as the forces required to mount the ring into its housing are high (around 250N). In addition, the function of the ring is to retain the gasket, while respecting the dimensions of the seat. However, the width of the seat, i.e. the axial dimension of the seat measured along the axis of engagement, is likely to vary due to the shape of the bead. This shape is difficult to control when the female end-piece is removed from the mold. As a result, the width of the seat is sometimes not controlled.

The present disclosure offers a simple, effective and economical solution that solves the problems of the prior art.

### SUMMARY

To this end, the disclosure proposes a female end-piece for a fluidic connector, this end-piece comprising:
a tubular body comprising an internal passage defining at least one fluid inlet and at least one fluid outlet, the internal passage comprising a first axis and being adapted to receive a male end-piece by engagement of the male end-piece in the female end-piece along said axis, the passage comprising an internal cylindrical surface extending around said axis and a first annular face which extends around said axis radially inwards from a first axial end of the cylindrical surface,
a retaining ring mounted in the passage, on the side of a second axial end of the cylindrical surface, opposite said first end, this ring defining a second annular face which extends around said axis radially inwards, the first and second annular faces facing each other axially and defining between them and with said cylindrical surface an annular seat opening radially inwards, and
an annular sealing gasket housed in said seat, the gasket being able to cooperate by axial abutment with said first and second annular faces respectively, and by radial abutment with said cylindrical surface and said male end-piece respectively,
the body comprising a first window for mounting the ring in the passage, said first window having a generally elongate shape in a plane perpendicular to said axis and being capable of allowing the ring to be mounted in the passage through it by translation of the ring in said plane.

The disclosure thus proposes replacing the mounting of the ring in the axial direction with a mounting of the ring in the transverse direction. To achieve this, the body of the female end-piece comprises a window for mounting the ring. This configuration is advantageous because it significantly reduces the effort required to mount the ring in the end-piece. In the prior art, these forces are high because they are equivalent to the forces required to extract the ring axially from the end-piece, so to avoid an accidental extraction of the ring from the end-piece, the forces required for this extraction are very high. In contrast, in the scope of the present disclosure, as the ring is mounted in the transverse direction, the forces required to mount it are independent of the forces required to accidentally extract the ring from the end-piece in the axial direction. The disclosure therefore allows to mount the ring manually into the female end-piece, with or without the help of a special machine. The mounting forces of the ring are oriented in the aforementioned plane, radially towards the axis of the passage.

The end-piece according to the disclosure may comprise one or more of the following characteristics, taken alone or in combination with each other:
the window also has a generally curved or arcuate shape around said axis;
the window has a maximum length which is at least 70%, and preferably at least 80%, of an external diameter of the body at the level of which the window is located;
the window has a maximum length which is at most 90% of an external diameter of the body at the level of which the window is located;
the window opens radially directly on the side of said second axial end of the cylindrical surface;
the ring is mounted in the passage through the window by resilient snap-fit and/or force fit;
the body comprises a second window diametrically opposite the first window and capable of receiving a portion of the ring at the end of the mounting;
the first and second windows have different shapes and/or sizes;
the ring comprises at least one indexing element able to cooperate with at least one complementary element of the body;
the ring comprises:
   an annular base extending around a second axis configured to coincide with the first axis when the ring is mounted in the passage,
   a first boss projecting from the base and extending radially outwards from the base,
   or even a second boss projecting from the base, diametrically opposite the first boss, and extending radially outwards from the base;
the first boss is complementary to the first window and is configured to occupy and close off this window when the ring is mounted in the body;
the second boss is complementary to the second window and is configured to occupy and close off this window when the ring is mounted in the body;
the first boss has a generally curved or arcuate shape about the second axis and has an angular extent about this second axis which is between 90 and 180°, and preferably between 90 and 130°;
the second boss has an angular extent about the second axis of between 10 and 45°, and preferably between 30 and 40°;
the first boss comprises two opposite circumferential ends respectively comprising two lateral faces parallel to each other and to the second axis and oriented radially outwards in opposite directions, these lateral faces being at a distance from each other which is greater than the maximum external diameter of the base;
the ring comprises at least two resilient snap-fit teeth which project from the base and extend radially outwardly from the base, these two teeth being diametrically opposed and adapted to be engaged in axial grooves in said passage;
the ring comprises at least one first indexing finger projecting axially from said first boss, or even a second indexing finger projecting axially from said second boss, the or each indexing finger being able to be engaged in a slot in the body;
the base comprises an internal frustoconical surface which extends over at least 80%, or even 90%, of its length or axial dimension measured along the second axis;
the or each boss is formed on an external cylindrical surface which extends over at least 80% or even 90% of its axial length or dimension measured along the second axis;
the ring comprises at least one lightening recess, which opens, for example, on the side of said second annular face;
the ring comprises ribs projecting from at least one face of the ring perpendicular to the axis and/or from at least one face of the ring parallel to the second axis, these ribs having an elongate shape and extending parallel to said plane, these ribs being capable of cooperating by bearing and sliding with the body during the mounting of the ring so as to create hard points during this mounting;
the ring is made of a single piece;
the first annular face is perpendicular to the axis;
the second annular face is perpendicular to the axis;
the ring is rigid and not elastically deformable;
the ring extends continuously through 360° around the first axis;
the ring is not split;
the body of the female end-piece also comprises two diametrically opposed slots suitable for receiving the lateral legs of a metal pin;
the metal pin is capable of axially retaining the male end-piece in the female end-piece;
the body of the female end-piece is made of a plastic or composite material, and/or the ring of the female end-piece is made of a plastic or composite material; the gasket is elastically deformable and is made, for example, of elastomer or equivalent;
the ring is of the non-removable type, i.e. it is not configured to be dismantled and would be damaged if dismantled;
the end-piece further comprises an indicator formed by a part carried by the ring and movable between a position at least partially hidden, referred to as the hidden position, and a position at least partially visible, referred to as the visible position; in the present application, the indicator is a visual indicator of correct connection, i.e. an indicator which allows to identify visually whether the fluidic connector is correctly connected or not; in particular, when the indicator is in its hidden position, the connector is not connected or correctly connected, i.e. the male end-piece is not engaged or correctly engaged in the female end-piece, and when the indicator is in its visible position, the connector is correctly connected, i.e. the male end-piece is correctly engaged in the female end-piece; advantageously, the indicator is moved from its hidden position to its visible position only once when the male end-piece is first engaged in the female end-piece; the movement of the indicator is then of the non-reversible type; advantageously, the indicator is moved from its hidden position to its visible position automatically when the male end-piece is inserted in the female end-piece;
the indicator is movable between the hidden and visible positions in a direction parallel to said axis;
the indicator is mounted and is movable in a notch in the ring;
the indicator comprises at least one elastic element capable of cooperating by elastic snap-fitting with the ring, which comprises a first orifice for receiving this elastic element when the indicator is in its hidden position, and a second orifice for receiving this elastic element when the indicator is in its visible position; the cooperation of the elastic element with these orifices allows to positively define the two positions of the indicator; moreover, the engagement of the elastic element in the second orifice may allow to prevent the indicator from returning to its ehidden position;
the indicator is generally L-shaped or angled and comprises a first tab oriented parallel to said axis and a second tab connected to the first tab and oriented radially with respect to said axis;
the first tab comprises a surface oriented radially outwards with respect to said axis, this surface being at least partially hidden when the indicator is in the hidden position, and being at least partially visible when the indicator is in the visible position;
the surface comprises a visual or identifiable marker selected from a color, a mark, a QR code and a DM code;
the second tab comprises a radially inner edge capable of cooperating by bearing with said male end-piece so as to move the indicator from its hidden position to its visible position; the radially inner edge is concavely curved and/or chamfered; the indicator is mounted in or at the level of one of said bosses; the ring comprises a guide channel for guiding the indicator between its two positions.

The disclosure also relates to a fluidic connector comprising a female end-piece as described above, and a male end-piece suitable for being engaged in the passage of the female end-piece along said first axis.

The fluidic connector according to the disclosure may comprise one or more of the following characteristics, taken in isolation from each other or in combination with each other:
the male end-piece comprises an annular groove which opens radially outwards;
the male end-piece has no gasket;
the male end-piece comprises two external cylindrical surfaces of different diameters connected together by a frustoconical surface;
the groove is formed on the cylindrical surface with the largest diameter;
the male end-piece comprises an indexing element capable of cooperating by engagement in an axial direction with a complementary element of the body of the female end-piece;
the connector is of the VDA type or other quick-connect system;
the end-piece is made of plastic or composite material;
the male end-piece comprises an external frustoconical surface suitable for bearing axially on the indicator in order to move it from its hidden position to its visible position when the male end-piece engages in the passage of the female end-piece.

### BRIEF DESCRIPTION OF THE FIGURES

Further characteristics and advantages will be apparent from the following description of non-limiting embodiments of the disclosure with reference to the accompanying drawings wherein:

FIG. 1 is a schematic perspective view of a fluidic connector according to the disclosure,

FIG. 2 is a schematic perspective view of a male end-piece of the fluidic connector in FIG. 1,

FIG. 3 is a schematic perspective view of a female end-piece of the fluidic connector in FIG. 1,

FIG. 4 is a schematic front view of the female end-piece in FIG. 3,

FIG. 5 is a schematic perspective view of a pin of the fluidic connector in FIG. 1,

FIG. 6 is a schematic perspective view of the female end-piece in FIG. 3, on which the pin in FIG. 5 is mounted,

FIG. 7 is a schematic axial cross-section of the female end-piece and of the pin of FIG. 6, along line VII-VII,

FIG. 8 is another schematic axial cross-sectional view of the female end-piece and of the pin of FIG. 6, along line VIII-VIII,

FIG. 9 is another schematic axial sectional view of the female end-piece and of the pin of FIG. 6, along line IX-IX,

FIG. 10 is a schematic perspective view of a ring of the fluidic connector in FIG. 1,

FIG. 11 is another schematic perspective view of the ring of the fluidic connector in FIG. 1,

FIG. 12 is a schematic perspective view of a gasket in the fluidic connector of FIG. 1,

FIG. 13 is a schematic axial sectional view of the fluidic connector in FIG. 1,

FIG. 14 is a schematic perspective view of the ring in FIG. 10 with the gasket in FIG. 12,

FIG. 15 is a schematic perspective view of the fluidic connector in FIG. 1 and shows a step wherein the ring is mounted into the female end-piece,

FIG. 16 is a partial schematic perspective view of the fluidic connector in FIG. 1 and shows the ring in the final stages of mounting in the female end-piece,

FIG. 17 is a schematic cross-sectional view of the fluidic connector in FIG. 1 at the level of the ring,

FIG. 18 is a schematic perspective view of a variant embodiment of a female end-piece for a fluidic connector according to the disclosure, and illustrates an indicator in a hidden position,

FIG. 19 is a schematic front view of the female end-piece in FIG. 18,

FIG. 20 is a schematic perspective view of a ring and an indicator of the female end-piece of FIG. 18,

FIG. 21 is another schematic perspective view of the ring and of the indicator of the female end-piece in FIG. 18,

FIG. 22 is a schematic axial cross-section of the ring and of the indicator of the female end-piece of FIG. 18,

FIG. 23 is another schematic perspective view of the indicator of the female end-piece in FIG. 18,

FIG. 24 is another schematic perspective view of the ring of the female end-piece in FIG. 18,

FIG. 25 is a schematic perspective view of the female end-piece in FIG. 18, and shows the indicator in a visible position,

FIG. 26 is a schematic perspective view of the ring and of the indicator of the female end-piece in FIG. 25, and

FIG. 27 is a schematic axial sectional view of the ring and of the indicator of the female end-piece of FIG. 25.

### DETAILED DESCRIPTION

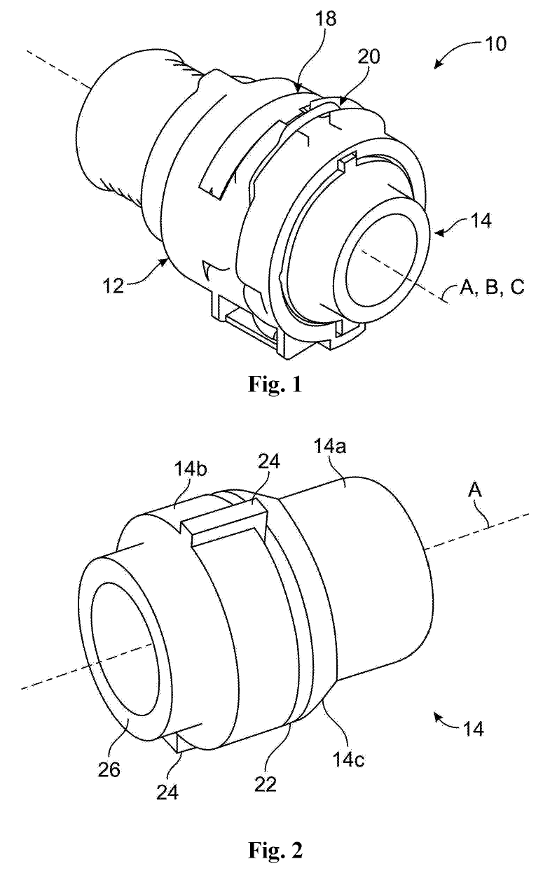

FIGS. 1-17 illustrate a first embodiment of the disclosure.

The disclosure relates both to a female end-piece for a fluidic connector and to a fluidic connector comprising this female end-piece.

FIG. 1 shows the fluidic connector 10 as a whole. Essentially, this connector 10 comprises two elements, namely a female end-piece 12 and a male end-piece 14.

As will be seen below, the female end-piece 12 comprises a sealing gasket 18 and a retaining ring 16 for retaining this gasket.

In addition, in the example shown, the female end-piece 12 is a metal pin 20, although this aspect is not restrictive.

In the example shown, the connector 10 is of the VDA type, although the disclosure is not limited to this application and may be of the SAE type or any other type for example.

### Male end-piece

FIG. 2 shows the male end-piece 14 and more specifically an example of male end-piece 14. The end-piece 14 is generally tubular along an axis A.

In the example shown, the end-piece 14 comprises two external cylindrical surfaces 14a, 14b of different diameters connected to each other by a frustoconical surface 14c.

The end-piece 14 comprises an annular groove 22 which opens radially outwards and which is configured to cooperate by elastic snap-fit with the pin 20 when the connector 10 is equipped with such a pin 20. The groove 22 may be formed on the cylindrical surface 14b of larger diameter.

The end-piece 14 may comprise an indexing element adapted to co-operate by engagement in an axial direction with a complementary element of female end-piece 12. In the example shown, the end-piece comprises two projecting fins 24, diametrically opposed with respect to the axis A, and having an elongated shape along the axis A. These fins 24 may be located on the cylindrical surface 14b of larger diameter.

In this example of embodiment, the end-piece 14 has no sealing gasket.

The end-piece 14 is preferably made of plastic or composite material.

The end 26 of the end-piece 14 opposite the smaller diameter surface 14a may be configured to be fitted and attached to a pipe or a tube, for example by welding, gluing or mechanical attachment.

### Female end-piece

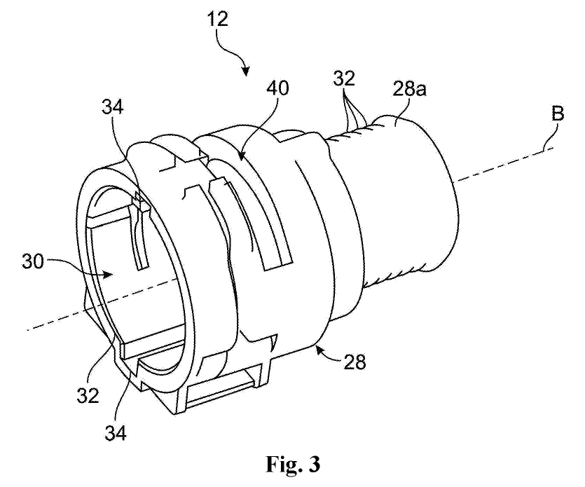

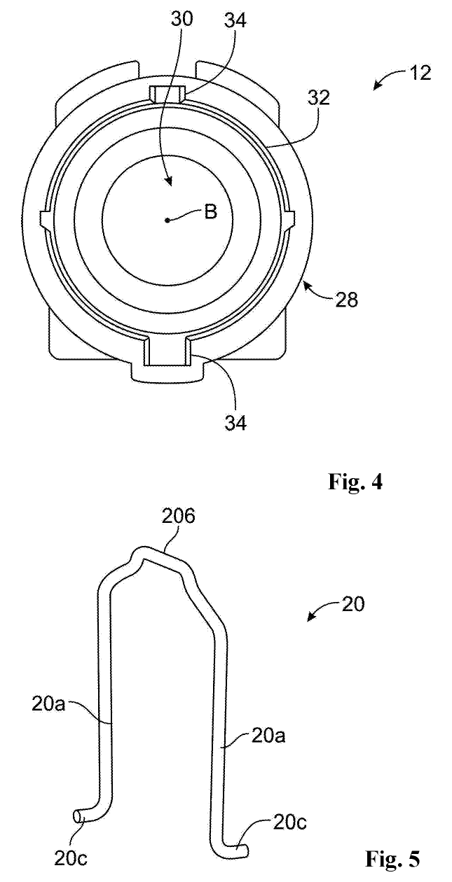

FIGS. 3 and 4 show the female end-piece 12 and more particularly a body 28 of this female end-piece 12. The end-piece 12, and in particular its body 28, is generally tubular and elongated, but may alternatively be bent into an L shape, or even a different shape such as a T or Y.

The body 28 comprises an internal passage 30 defining at least one fluid inlet and at least one fluid outlet.

The passage 30 comprises an axis B which is able to receive the male end-piece 14 by engagement of the male end-piece 14 in the female end-piece 12 along this axis B. When the end-pieces 12, 14 are mounted one inside the other, their respective axes A, B are configured to merge.

In the example shown, the body 28 comprises a section 28a for connecting the body 28 to a pipe or a tube. This section 28a may comprise radially external annular teeth 32 to allow the section 28a to be mechanically anchored in a pipe, for example.

The male end-piece 14 is configured to be engaged in the female end-piece 12 on the side opposite this section 28a. The passage 30 thus opens on the side opposite the section 28a, to form an opening 32 for engagement of the male end-piece 14.

The opening 32 has a complementary shape to that of the male end-piece 14 and is visible from the front in FIG. 4. It may be seen that the opening 32 comprises the complementary indexing element configured to cooperate with the male end-piece 14. In the example shown, the end-piece 12 comprises two slots 34, diametrically opposed with respect to the axis B, and having an elongated shape along the axis B, to accommodate the fins 24 when the male end-piece 14 engages in the female end-piece 12.

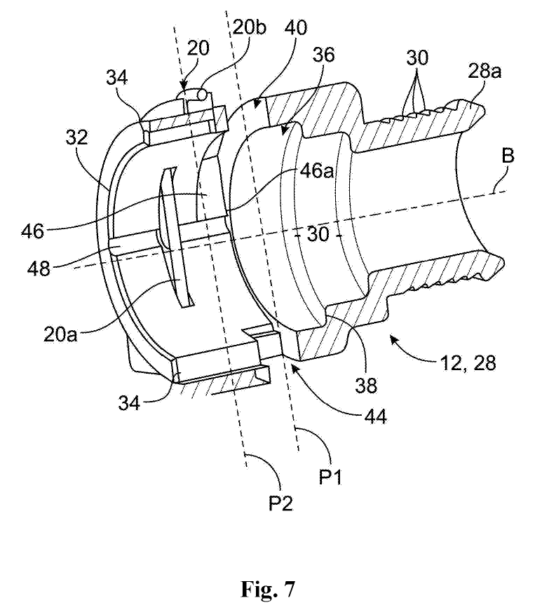

In FIGS. 7-9, it may be seen that the passage 30 comprises on the one hand an internal cylindrical surface 36 which extends around the axis B and on the other hand a first annular face 38 which extends around the axis B radially inwards from a first axial end of the cylindrical surface 36. The first face 38 is preferably perpendicular to the axis B.

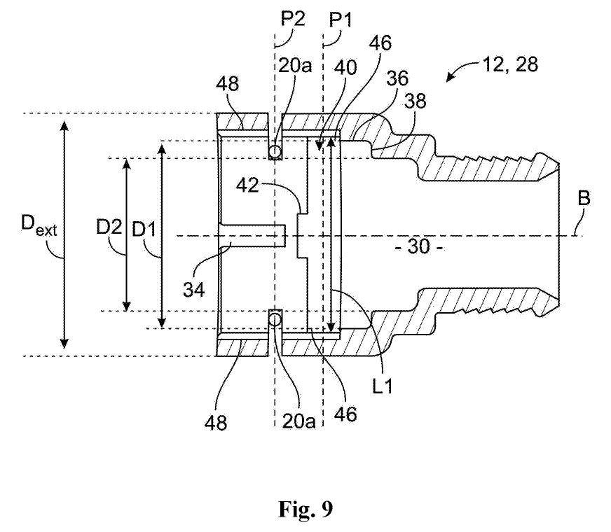

The cylindrical surface 36 has a diameter D1 (FIG. 9). The first face 38 has an internal diameter D2, smaller than D1.

The particularity of the body 28 is that it comprises a first window 40 for mounting the ring 16 in the passage 30, this window 40 being visible in particular in FIGS. 3, 7 and 9.

The window 40 has a generally elongated shape in a plane P1 perpendicular to the axis B and is adapted to allow the ring 16 to be mounted in the passage 30 through it by translation of the ring 16 in the plane P1.

The window 40 preferably has a generally curved or arcuate shape around the axis B, as may be seen in FIGS. 3 and 9.

The window 40 may have a maximum length L1 which is at least 70%, and preferably at least 80%, of an external diameter Dext of the body at the level of which the window 40 is located (FIG. 9). The maximum length L1 may not exceed 90% of the external diameter Dext.

The window 40 preferably opens radially directly on the side of the second axial end of the cylindrical surface 36, which is opposite the aforementioned first end.

FIG. 9 shows that the window 40 may be generally T-shaped and comprise a slot 42 substantially in its middle. This slot 42 preferably extends in a radial direction with respect to the axis B.

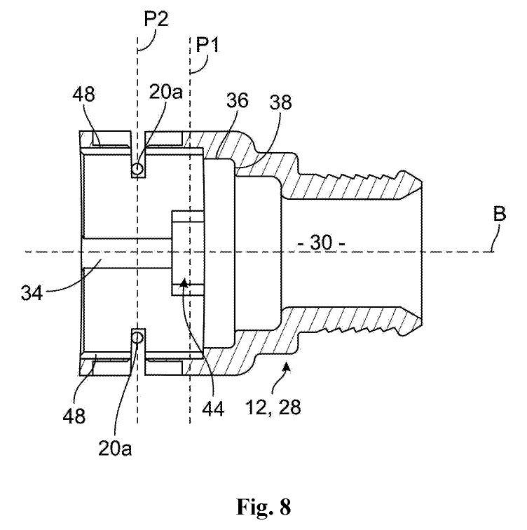

Advantageously, the body 28 comprises a second window 44 diametrically opposite the first window 40 and able to receive a portion of the ring 16 at the end of mounting (FIGS. 7 and 8). This slot 44 preferably extends in a radial direction with respect to the axis B and may be connected to one of the aforementioned slots 34, or coincide with one of these slots 34.

Preferably, the first and second windows 40, 44 have different shapes and/or dimensions.

As may be seen in FIG. 7, the window 40 opens into the passage 30 forming two ramps 46 which are substantially parallel to each other and to the axis B. Each of these ramps 46 extends from the outer periphery of the body 26 to an axial groove 48 formed inside the body, in the passage 30. It is therefore understood that the passage 30 comprises two axial grooves 48 which may be diametrically opposed. FIGS. 4 and 7-9 show that these grooves 48 may extend from the aforementioned second end of the cylindrical surface 36 to the opening 32 of the passage 30.

FIG. 9 also shows that the aforementioned length L1 is measured between the ramps 46. In addition, each of the ramps 46 may be connected to its groove 48 by a change of slope 46a tending to reduce this length L1 (FIG. 7).

The ring 16 is mounted in the passage 30 through the window 40 preferably by resilient snap-fitting and/or force-fit, as will be described in more detail below.

The body 28 of the end-piece 12 is preferably made of a plastic or composite material.

The body 28 of the female end-piece 14 also comprises two diametrically opposed slots 50 suitable for receiving the pin 20.

### Pin

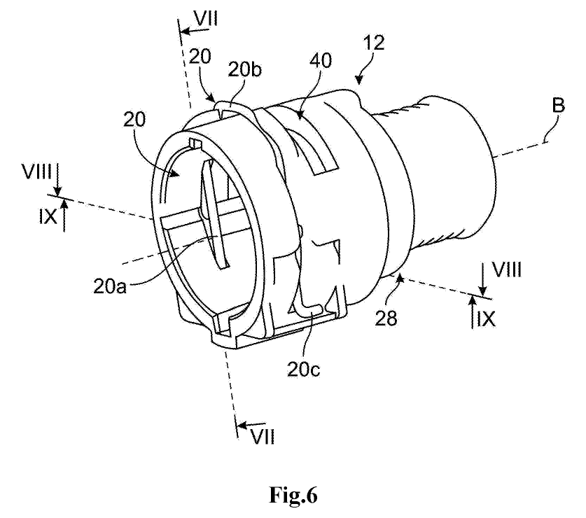

The pin 20 is shown on its own in FIG. 5 and mounted on the body 28 of the female end-piece 12 in FIGS. 6-9 in particular.

This pin 20, known per se, is formed by a metal rod which is shaped to have a U or horseshoe form.

The pin 20 comprises two lateral legs 20a connected together by a median portion 20b. Each of the legs 20a extends from the median portion 20b to a free end 20c which is bent or curved.

The pin 20 is able to retain the male end-piece 14 axially in the female end-piece 12. To do this, its legs 20a are mounted in the slots 50 of the body 28.

The pin 20 is mounted astride the body 28 so that its median portion 20b extends around the body 28 and its legs 20a are located on either side of the body 28 in the aforementioned slots 50. The free ends 20c of the legs 20a are capable of cooperating by elastic snap-fitting with complementary shapes on the outer periphery of the body so that the pin 20 may adopt two positions in another plane P2 perpendicular to the axis B:
a first position, referred to as the upper position, not shown in the drawings, wherein engagement of the male end-piece 14 in the female end-piece 12 causes the legs 20a to move apart and bear and slide on the frustoconical surface 14c of the end-piece 14 as the end-piece 14 is engaged in the end-piece 12, the translation of the male end-piece 14 in the female end-piece 12 being continued until the legs 20a engage by elastic snap-fitting in the groove 22 of the end-piece 14 to retain it axially in the end-piece 12,
a second position, known as the lower or locking position, shown in the drawings, particularly in FIG. 6, wherein the free ends 20c of the legs 20a are held radially outwards by the outer periphery of the body 28, which prevents the legs 20a from moving apart and prevents accidental disassembly of the end-piece 14 from the end-piece 12.

### Retaining ring

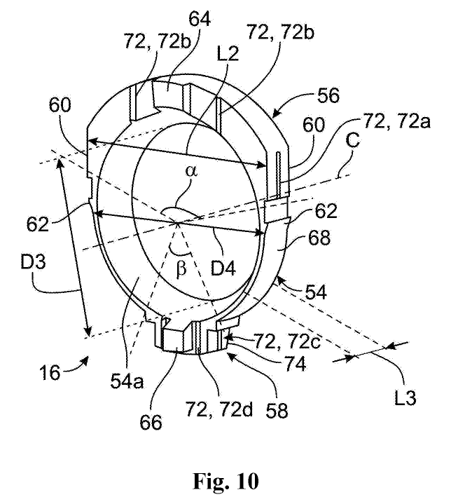

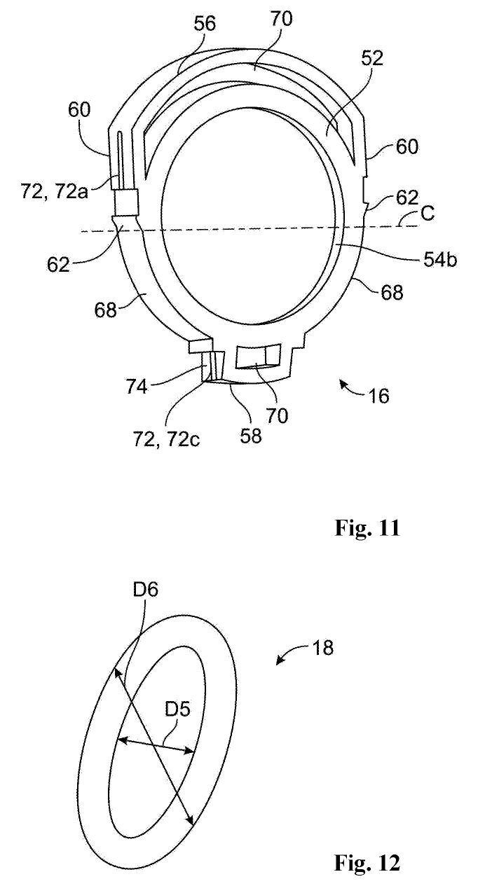

Reference is now made to FIGS. 10 and 11, which show the retaining ring 16 on the female end-piece 12.

The ring 16 has a generally annular shape about an axis C which is configured to merge with the axis B when the ring 16 is mounted in the passage 30 of the body 28.

The ring 16 is preferably rigid and not elastically deformable. It extends continuously through 360° around the axis C. The ring 16 is therefore not split.

The ring 16 is configured to be mounted on the side of the aforementioned second axial end of the cylindrical surface 36.

The ring 16 defines a second annular face 52 which extends radially inwards around the axis C and which is configured to be located axially opposite the aforementioned first face 38 of the passage 30. The second side 52 is preferably perpendicular to the axis C.

The second face 52 has an internal diameter D3, close to D2 or equal to D2.

The faces 38, 52 define between them and with the cylindrical surface 36 an annular seat 53 which opens radially inwards to house the sealing gasket 18.

In the present application, "close" dimensions are understood to mean dimensions that differ from one another by +/-10%.

Advantageously, as in the example shown, the ring 16 comprises:
an annular base 54 which extends around the axis C,
a first boss 56 projecting from the base 54 and extending radially outwards from the base 54,
and preferably also a second boss 58 projecting from the base 54, diametrically opposite the first boss 56, and extending radially outwards from the base 54.

The first boss 56 is preferably complementary to the first window 40 and is configured to occupy and close off this window 40 when the ring 16 is mounted in the body 28, as may be seen in FIG. 1 for example.

The second boss 58 is also preferably complementary to the second window 44 and is configured to occupy and close off this window 44 when the ring 16 is mounted in the body 16.

In the example shown, the first boss 56 has a generally curved or arcuate shape about the axis C and has an angular extent a about the axis C which is for example between 90 and 180°, and preferably between 90 and 130°.

The second boss 58 may have an angular extent b about the axis C which is, for example, between 10 and 45°, and preferably between 30 and 40°.

Preferably, the first boss 56 comprises two opposite circumferential ends respectively comprising two lateral faces 60 parallel to each other and to the axis C and oriented radially outwards in opposite directions.

The lateral faces 60 are at a distance L2 from each other which is greater than the maximum external diameter D4 of the base 54.

The ring 16 preferably comprises at least two resilient snap-fit teeth 62 which project from the base 54 and extend radially outwards from the base 54.

The teeth 62 are diametrically opposed and may be engaged respectively in the aforementioned axial grooves 48 of the passage.

The ring 16 may also comprise at least one indexing element able to cooperate with at least one complementary element of the body 28.

In the example shown, the ring 16 comprises at least one first indexing finger 64 projecting axially from the first boss 56, and possibly also a second indexing finger 66 projecting axially from the second boss 58.

The fingers 64, 66 project from the same side of the ring 16.

The fingers 64, 66 may be engaged in the aforementioned slots 42, 44 in the body 28. It is therefore understood that the finger 64 has a complementary shape to the slot 42 wherein it is configured to be engaged, and that the finger 66 has a complementary shape to the slot 44 wherein it is configured to be engaged.

Preferably, the fingers 64, 66 have different shapes and/or dimensions.

In the example shown, the base 54 comprises an internal frustoconical surface 54a which extends over at least 80%, and possibly 90%, of the length L3 or axial dimension of the base measured along the axis C. Over the remainder of its length, the base 54 may comprise a cylindrical surface 54b visible in FIG. 11. This surface 54a may make it easier to guide the male end-piece 14 into the female end-piece 12, for example by cooperating with the cylindrical surface 14s of the male end-piece 14.

The or each boss 56, 58 may be formed on an outer cylindrical surface 68 of the base 54 which extends over at least 80% or even 90% of its length L3 or axial dimension measured along the axis C. The outer cylindrical surface 68 of the base 54 may extend over 100% of the length L3.

In addition, the ring 16 may comprise at least one lightening recess 70, which opens out, for example, on the side of the second annular face 52. The or each recess 70 is preferably of the blind type. Two recesses 70 may be formed in the two bosses 56, 58 respectively, for example.

Advantageously, the ring 16 comprises ribs 72 projecting from at least one face of the ring perpendicular to the axis C and/or from at least one face of the ring parallel to the axis C.

These ribs 72 are preferably elongated and extend parallel to the plane P1.

The ribs 72 are able to cooperate by bearing and sliding with the body 28 during the mounting of the ring 16 so as to create hard points during this mounting.

The ribs 72 may be formed on the bosses 56, 58 as in the example shown.

The boss 56 may, for example, comprise ribs 72a on these faces 60, and ribs 72b on the face of the boss 56 opposite the face 52. There are two ribs 72a, for example, centered on the faces 60. The ribs 72b, for example, are located on either side of the finger 64.

The boss 58 may, for example, comprise ribs 72c on lateral faces 74 parallel to the faces 60, and ribs 72d on the face of the boss 58 opposite the face 52. There are two ribs 72c, for example, centered on the faces 74. The ribs 72d, for example, are located on either side of the finger 66.

The ring 16 is preferably made of a single piece of plastic or composite material.

### Gasket

The gasket 18 is shown on its own in FIG. 12. In the example shown, this is an O-ring type annular gasket.

The gasket 18 is elastically deformable and is made, for example, of elastomer or equivalent.

Alternatively, the gasket 18 may be different and may, for example, be a lip gasket, for example with a general V-shape in cross-section.

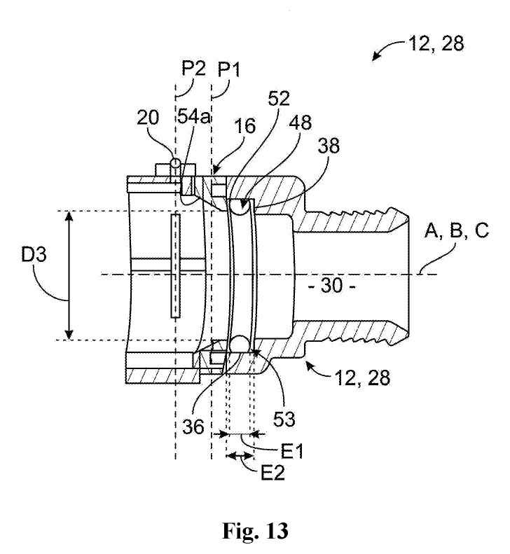

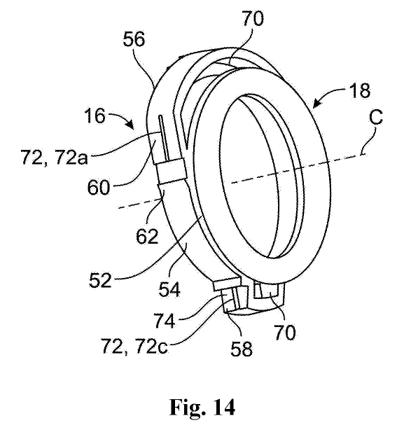

FIGS. 13 and 14 show that the gasket 18, in the unstressed state, has an internal diameter D5 which is close to the diameters D2 and D3 or less than these diameters D2 and D3, and an external diameter D6 which is close to the diameter D1 or greater than this diameter D1.

FIG. 13, which shows the gasket 18 mounted in the seat 53 of the female end-piece 12, also shows that the gasket 18 is able to cooperate by axial abutment with the faces 38 and 52 respectively, and by radial abutment with the surface 36 and the male end-piece 14 (in particular its surface 14a) respectively. It may also be seen that the thickness E1 or axial dimension of the seat 53 may be greater than the thickness E2 or axial dimension of the gasket 18.

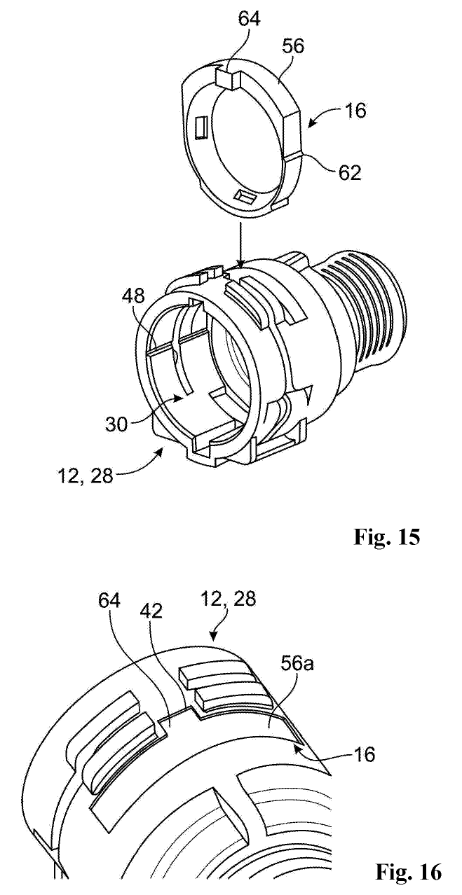

Reference is now made to FIGS. 15-17, which illustrate at least one mounting step for mounting the female end-piece 12 and, in particular, mounting the ring 16 on the body 28 of the end-piece 12.

The ring 16 is mounted on the body 28 before or after the pin 20 is mounted on the body 28.

The gasket 18 is mounted into the passage 30 of the body 28 by aligning the axis of the gasket 18 with the axis B of the body 28 and then moving the gasket 18 towards the body 28, until the gasket is surrounded by the surface 36 of the passage. The gasket 18 may then rest axially on the face 38.

The ring 16 is then mounted into the passage 30 through the slot 40, as shown in FIG. 15. The ring 16 is moved in plane P1 by first engaging the side of the ring 16 opposite its first boss 56, this side may comprise the aforementioned second boss 58.

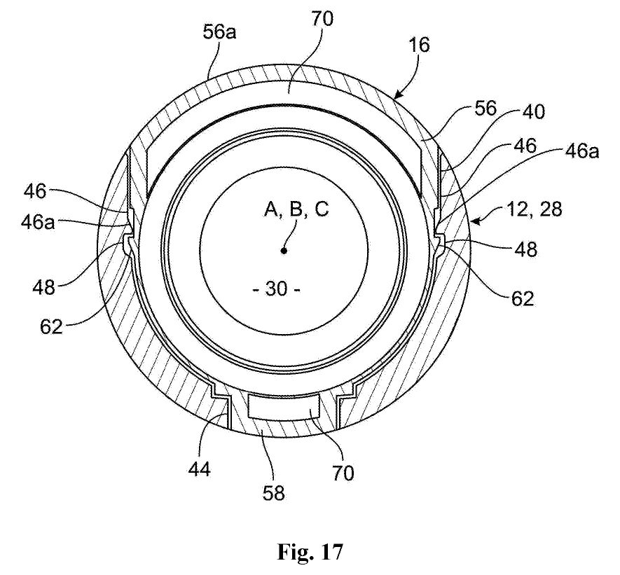

A force, preferably manual, is exerted on the ring 16 in the plane P1 in the direction of the axis C to force the ribs to slide on the surfaces facing the body 28 of the end-piece 12. The faces 60 of the ring 16 cooperate by sliding with the ramps 46 of the body 28 to facilitate the guidance during the mounting. The mounting is complete when the teeth 62 of the ring are housed by resilient snap-fit in the grooves 48 of the body 28, as shown in FIG. 17. In this position, the first boss 56 is housed in the window 40 and the second boss 58 is housed in the window 44. The outer periphery of the first boss 56 may comprise an outer surface 56a in the form of a segment of a cylinder which is aligned with an outer cylindrical surface of the body 28 so as to render the ring virtually invisible and advantageously virtually ungraspable by hand or by a tool insofar as the ring 16 is not configured to be dismantled.

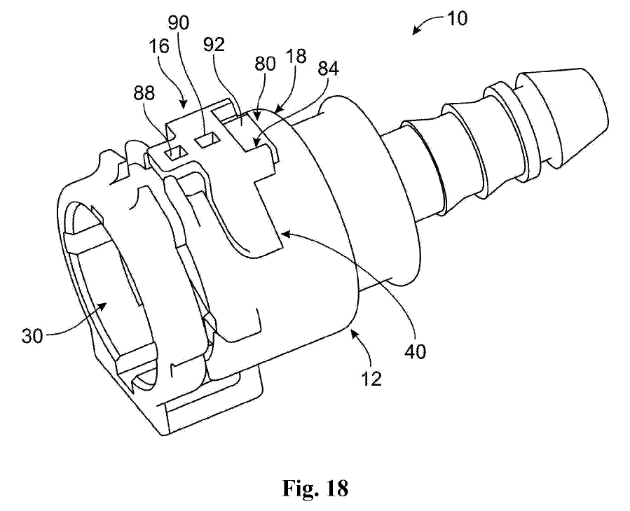

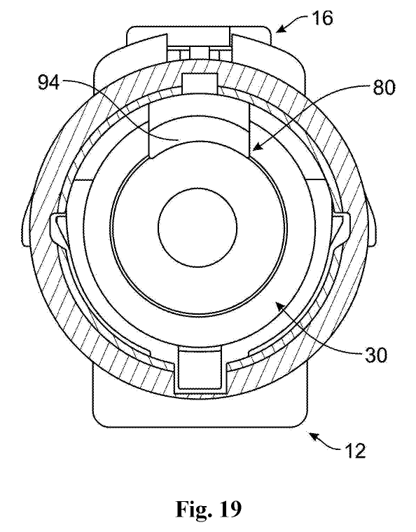

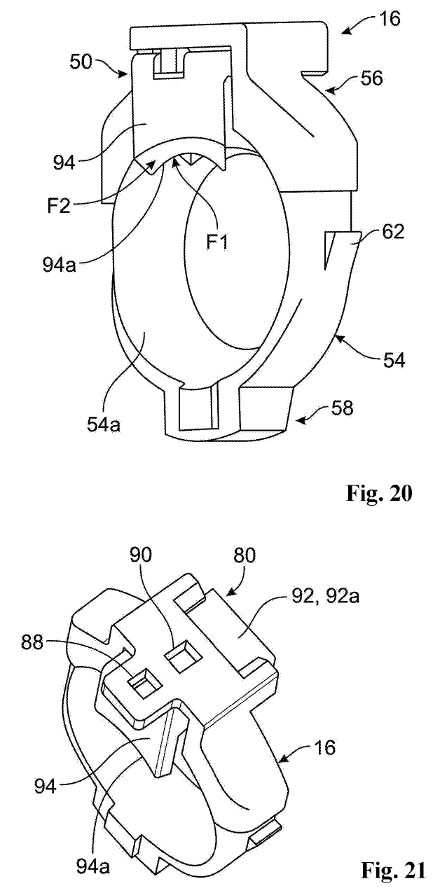

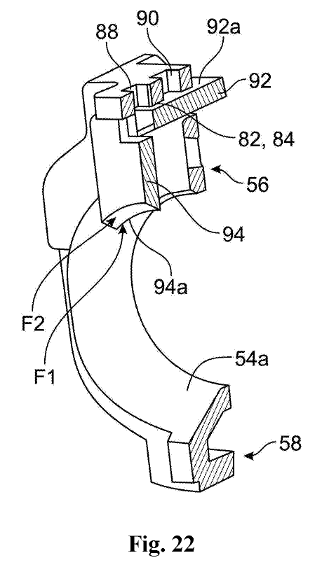

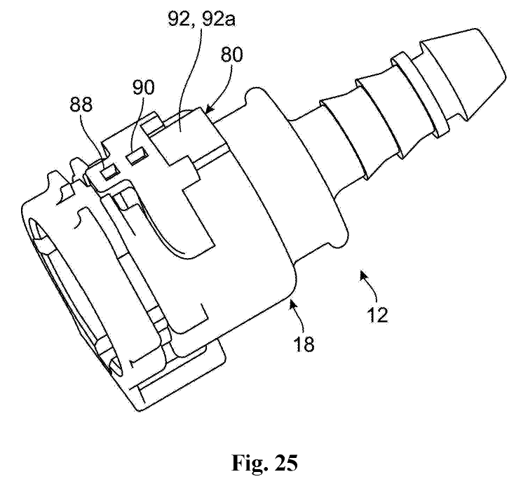

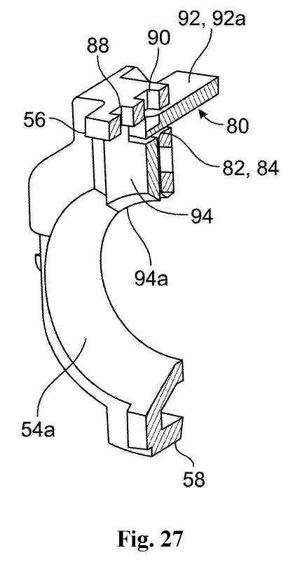

FIGS. 18-27 illustrate an alternative embodiment of the disclosure. In these figures, the elements already described above are designated by the same references. The foregoing description with reference to FIGS. 1-17 therefore applies to this variant insofar as it does not contradict or conflict with what follows.

In this variant, the female end-piece 12 also comprises an indicator 80 formed by a part carried by the ring 16 and movable between a position at least partially hidden, called the hidden position, and a position at least partially visible, called the visible position.

FIGS. 18-22 show the indicator 80 in its hidden position and FIGS. 25-27 show the indicator 80 in its visible position.

The indicator 80 is a visual indicator of a good connection, i.e. an indicator which allows to visually identify whether or not the fluidic connector is correctly connected.

When the indicator 80 is in its hidden position, the connector 10 is not connected or correctly connected, i.e. the male end-piece 14 is not engaged or correctly engaged in the female end-piece 12. When the indicator 80 is in its visible position, the connector 10 is correctly connected, i.e. the male end-piece 14 is correctly engaged in the female end-piece 12.

In the example shown, the indicator 80 moves from its hidden position to its visible position only once when the male end-piece 14 first engages in the female end-piece 12. The shift of the indicator is then of the non-reversible type. This movement is caused by the male end-piece 14 itself and in particular by its frustoconical surface 14c (FIG. 2) which is configured to bear axially on the indicator 80 in order to move it from its hidden position to its visible position.

Advantageously, the indicator 80 may be moved between the hidden and visible positions in a direction parallel to the axis C.

In the example shown, the indicator 80 is mounted and movable in a notch 82 in the ring 16, which preferably comprises a guide channel 84 for guiding the ring along the axis C. The indicator 80 may cooperate with the channel 84 in the form of a slide rail.

The indicator 80 preferably comprises at least one elastic element 86 capable of cooperating by elastic snap-fitting with the ring 16. The ring 16 may comprise a first orifice 88 for receiving this elastic element 86 when the indicator 80 is in its hidden position, and a second orifice 90 for receiving this elastic element 86 when the indicator 80 is in its visible position. The orifices 88, 90 may be located one behind the other along the axis C, as in the example shown.

The cooperation of the elastic element 86 with these orifices 88, 90 allows to positively define the two positions of the indicator 80 and to maintain them in these positions. The engagement of the elastic element 86 in the second orifice 90 may, for example, prevent the indicator 80 from returning to its hidden position.

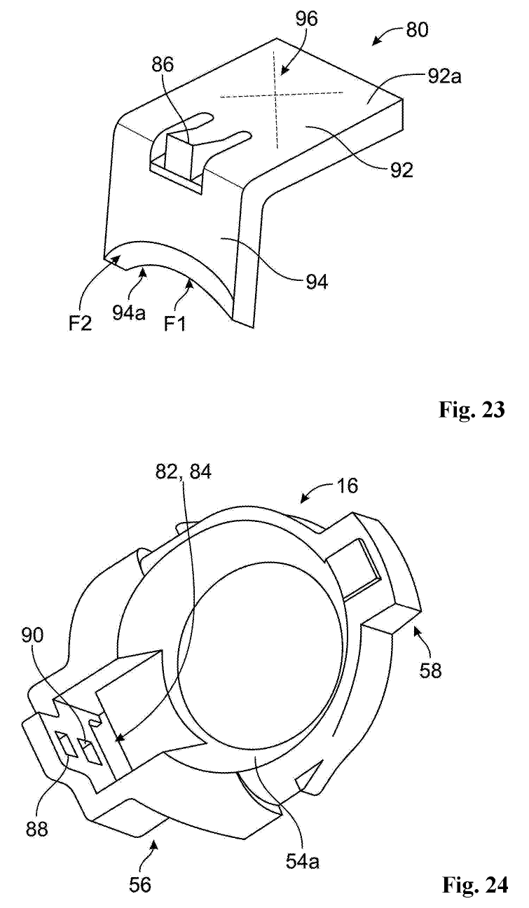

As in the example shown, the indicator 80 may be generally L-shaped or angled (FIG. 23) and comprise a first tab 92 oriented parallel to the axis C and a second tab 94 connected to the first tab 92 and oriented radially with respect to the axis C.

The first tab 92 may comprise a surface 92a oriented radially outwards with respect to the axis C. This surface 92a is at least partly hidden when the indicator 80 is in the hidden position (FIG. 18), and at least partly visible when the indicator 80 is in the visible position (FIG. 25).

The surface 92a may comprise a visual or identifiable marker 96 chosen from a color, a mark, a QR code and a DM code (FIG. 23).

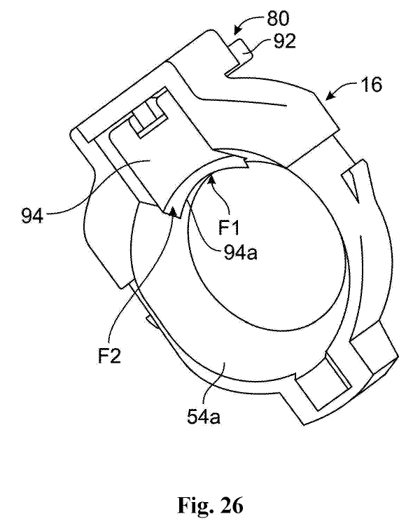

The second tab 94 may comprise a radially inner edge 94a able to cooperate by bearing with the male end-piece 14 as mentioned above. This edge 94a may be concavely curved as indicated by arrow F1 and/or chamfered as indicated by arrow F2. Advantageously, the chamfer is designed to be substantially aligned with the internal frustoconical surface 54a of the ring 16 when the indicator 80 is in its visible position (FIG. 26).

In the example shown, the indicator 80 is mounted in or at the level of one of the bosses 56, 58, and in particular the boss 56.

It is understood that in the example shown, the indicator 80 is mounted in the notch 82 of the ring 16 before the ring 16 is mounted in the window 40 of the body 28 of the female end-piece 12. This makes the indicator 80 captive.

1. A female end-piece for a fluidic connector, this end-piece comprising:
a tubular body comprising an internal passage defining at least one fluid inlet and at least one fluid outlet, the internal passage comprising a first axis (B) and being adapted to receive a male end-piece by engagement of the male end-piece in the female end-piece along said axis (B), the passage comprising an internal cylindrical surface extending around said axis (B) and a first annular face which extends around said axis (B) radially inwards from a first axial end of the cylindrical surface,
a retaining ring mounted in the passage, on a side of a second axial end of the cylindrical surface, opposite said first end, this ring defining a second annular face which extends about said axis (B) radially inwards, the first and second annular faces facing each other axially and defining between them and with said cylindrical surface an annular seat opening radially inwards, and
an annular sealing gasket housed in said seat, the gasket being able to cooperate by axial abutment with said first and second annular faces respectively, and by radial abutment with said cylindrical surface and said male end-piece respectively,
the body comprising a first window for mounting the ring in the passage, this first window having a generally elongate shape in a plane (P1) perpendicular to said axis (B) and being capable of allowing the ring to be mounted in the passage through it by translation of the ring in said plane (P1), and
the end-piece also comprising an indicator formed by a part carried by the ring and movable between a position at least partially hidden, referred to as the hidden position, and a position at least partially visible, referred to as the visible position, said indicator preferably being configured to move from its hidden position to its visible position when the male end-piece engages in the passage of the female end-piece.

2. The end-piece according to claim 1, wherein the indicator is movable between the hidden and visible positions in a direction parallel to said axis (B).

3. The end-piece according to claim 2, wherein the indicator is mounted and is movable in a notch in the ring.

4. The end-piece according to claim 2, wherein the indicator comprises at least one elastic element capable of cooperating by elastic snap-fitting with the ring which comprises a first orifice for receiving this elastic element when the indicator is in its hidden position, and a second orifice for receiving this elastic element when the indicator is in its visible position.

5. The end-piece according to claim 2, wherein the indicator is generally L-shaped or angled and comprises a first tab oriented parallel to said axis (B) and a second tab connected to the first tab and oriented radially with respect to said axis (B).

6. The end-piece according to claim 1, wherein the indicator is mounted and is movable in a notch in the ring.

7. The end-piece according to claim 1, wherein the indicator comprises at least one elastic element capable of cooperating by elastic snap-fitting with the ring which comprises a first orifice for receiving this elastic element when the indicator is in its hidden position, and a second orifice for receiving this elastic element when the indicator is in its visible position.

8. The end-piece according to claim 1, wherein the indicator is generally L-shaped or angled and comprises a first tab oriented parallel to said axis (B) and a second tab connected to the first tab and oriented radially with respect to said axis (B).

9. The end-piece according to claim 8, wherein the first tab comprises a surface oriented radially outwards with respect to said axis (B), this surface being at least partially hidden when the indicator is in the hidden position, and being at least partially visible when the indicator is in the visible position.

10. The end-piece as claimed in claim 9, wherein the surface comprises a visual or identifiable marker selected from a color, a mark, a QR code and a DM code.

11. The end-piece according to claim 9, wherein the second tab comprises a radially inner edge capable of cooperating by bearing with said male end-piece so as to move the indicator from its hidden position to its visible position.

12. The end-piece according to claim 8, wherein the second tab comprises a radially inner edge capable of cooperating by bearing with said male end-piece so as to move the indicator from its hidden position to its visible position.

13. The end-piece as claimed in claim 12, wherein the radially inner edge is concavely curved and/or chamfered.

14. The end-piece according to claim 13, wherein the indicator is mounted in or at a level of a boss of the ring.

15. The end-piece according to claim 1, wherein the indicator is mounted in or at a level of a boss of the ring.

16. A fluidic connector comprising a female end-piece according to claim 1, and a male end-piece suitable for being engaged in the passage of the female end-piece along said first axis (B).

17. The fluidic connector according to claim 16, wherein the male end-piece comprises an external frustoconical surface suitable for bearing axially on the indicator in order to move it from its hidden position to its visible position when the male end-piece engages in the passage of the female end-piece.
